(19) United States
(12) Patent Application Publication
(10) Pub. No.: US 2012/0228983 A1
(43) Pub. Date: Sep. 13, 2012

(54) STATOR MODULE, IN PARTICULAR FOR MULTI-PHASE ELECTRIC MACHINES, AND METHOD FOR PRODUCING SUCH A STATOR MODULE

(75) Inventor: Wolfgang Hill, Karlsruhe (DE)

(73) Assignee: SCHAEFFLER TECHNOLOGIES AG & CO. KG, Herzogenaurach (DE)

(21) Appl. No.: 13/472,712

(22) Filed: May 16, 2012

Related U.S. Application Data
(63) Continuation of application No. PCT/DE2010/001250, filed on Oct. 26, 2010.

(30) Foreign Application Priority Data
Nov. 16, 2009 (DE) 10 2009 053 484.9
Dec. 21, 2009 (DE) 10 2009 059 737.9

(51) Int. Cl. H02K 3/28; H02K 15/00

(52) U.S. Cl. 310/208; 29/596

(57) ABSTRACT

The invention relates to a stator module for multi-phase machines, including a plurality of soft magnet stator segments that are individually wound with coils and that can be connected to a yoke, where the coils of a phase are connected in series. The stator module includes the stator segments of a phase form a stator segment chain, having at least two stator segments, the coils of which are formed by a winding wire free of interruptions.

### CROSS-REFERENCE TO RELATED APPLICATIONS

This application is filed under 35 U.S.C. §120 and §365(c) as a continuation of International Patent Application No. PCT/DE2010/001250, filed Oct. 26, 2010, which application claims priority from German Patent Application No. 10 2009 053 484.9 filed Nov. 16, 2009 and from German Patent Application No. 10 2009 059 737.9 filed Dec. 21, 2009, which applications are incorporated herein by reference in their entireties.

### FIELD OF THE INVENTION

The invention relates to a stator module for multi-phase electric machines.

The invention further relates to a method for producing such a stator module.

### BACKGROUND OF THE INVENTION

Electric machines, for example induction machines, are known from prior art in most different embodiments and for most different purposes of use. Such induction machines are used, among other things, as actuator motors in automatic transmissions. Here, they have to show a high power density with little spatial needs. This sets very high requirements for the production of stator modules with regards to the necessary spatial needs. Various methods are possible for the production of such stator modules. The first option is based on poles in the form of individual stator segments with individual coils being wound around them, where the stator segments wound here may be provided in large numbers in a pre-fabricated fashion and can be combined to stator modules as needed.

Segmented embodiments of stator modules including individual stator segments are known for example from German Patent Application No. 10 2009 004 391 A1. A stator module assembled therefrom shows a high slot space factor, because the winding occurs already in pre-fabricated units and it is not necessary to consider any spatial needs for the winding tool. The disadvantage of this design includes the fact that for each stator segment two contact sites develop, and thus, in a single stator showing a certain number of such segments a respective number of phase connections, and for example, a high number of contacts must be switched via switching units. A widely used solution to switch the coils of individually wound stator segments is the use of switching elements, assembled as punched parts at support structures or preliminarily injection molded at the face of the winding head of the coil. In weak currents circuit boards are also used as switching elements. For example, embodied support bodies and/or coil bodies made from plastic support the switching by positioning and fixating conductive elements. These switching units require space and cause costs.

Furthermore, the high number of contacts leads to a correspondingly high number of connecting operations to connect to the switching units. Here, each individual connection represents a potential source for errors in the production as well as in later operation.

A central electricity distribution member is known, for example, from the German Patent Application No. 10 2008 061 421 A1, for an electric inductive machine, which includes bus bars allocated to the individual phases to connect coils of the same phase arranged in the stator of the electric machine and a bus bar in the isolated section, which shows an annular holding groove to accept a respective bus bar and isolations between the respective bus bars.

When the arrangement of the switching occurs in the area of the yoke, which is quasi formed as a ring or in a segmented embodiment by individual stator segments, it is limited to motors with very high winding numbers, and thus, very thin winding wires. The majority of applications, however, include the winding numbers being rather few and the winding wires showing a greater thickness, and thus, diameter or different dimensions. In motors with higher numbers of poles the space available in front of the yoke is no longer sufficient for the required switching, leading to the switching of the individual polar coils to occur axially in front of the coil heads and requiring the necessary construction space here. Furthermore, in cases in which the stator module is impressed into a housing from the switching side, due to the increased space required for pressing in, any switching in the yoke area is impossible.

Furthermore, methods are known by which several poles of a phase can be wound continuously. For this purpose, generally fixing points are determined at the faces of the coil bodies which serve as deflection points during the winding process and/or fixate the ends of the coils. The coiling process of the wire about the deflection points also requires a lot of construction space and leads to an increase in the length of the conductor and winding loss.

An alternative embodiment forms an annular stator module including an angular sheet-metal package with the unfolded grooves being continuously wound with a winding needle and subsequently the winding is ended and the connection paths of the winding wires are guided with the help of switching elements axially in front of the coil heads.

When coiling several stator modules with a winding needle, the winding tool requires sufficient operating space in the pre-defined groove area. The coils are therefore not able to appropriately fill the groove space, leading to such embodiments including a low groove fill factor. The adjacent pole-forming stator segments are arranged at an enlarged distance during the winding process, leading to the connections between the coils arranged adjacent to each other in the circumferential direction showing excess lengths, rendering the final group of stator modules in need of increased space for the arrangement and fixation and increasing the loss of the circuitry.

Furthermore, some of the winding processes known can be used only for particular polar arrangements by the angles of adjacent coils requiring at least an angle of 90°.

Many of the embodiments of prior art require additional construction space in the axial direction in front of or behind the stator module for switching the segments of one phase and the individual phases to each other. Here, the additional construction length required in the axial direction frequently amounts to a multitude of the diameter the winding wire. Furthermore, the respective connection elements for the coupling or embodiment of an electric connection are accordingly large and increase the resistance of the strand, and thus, lead to winding loss.

An additional essential disadvantage of the known embodiments includes the fact that besides the additional need for construction space, the production as well as realization of the connections between the individual coil ends and the switching elements themselves are very expensive.

### BRIEF SUMMARY OF THE INVENTION

The object of the invention is to further develop a stator module for an electric machine with individually wound stator segments forming poles respectively, such that the required structural length of the stator module in the axial direction including the required switching is relatively short and the winding resistance for the windings of a phase can be kept low. The production shall be possible in industrial series with minimum costs and using an automated process, to the extent possible.

A stator module for multi-phase machines with a plurality of magnetically soft stator segments, arranged distanced from each other in the circumferential direction and here forming grooves and a yoke or potentially connected to a yoke, including wound coils, with at least two coils in a phase being switched serially, where at least two stator segments of a phase forming at least one stator segment chain, with its coils and the connection of the coils to each other being formed by at least one continuous winding wire. This way, within the stator segment chain only one continuous winding wire or several parallel-switched winding wires are used, which show appropriate connectors at the beginning and the end section, required to contact the feeding lines. Depending on the number of such stator segment chains here the number of contact sites to be realized in the stator module can be minimized to the number of phases. Furthermore, it is possible to provide the individual stator segments in a pre-fabricated fashion and to position the complete stator segment chain opposite an appropriate yoke or a housing and to align it or when forming the yoke to align them in reference to each other by the individual stator segments. Due to the continuity of the winding otherwise required connection sites of the individual coils of a phase switched serially, the connection element required for a subsequent connection, and the construction space for the arrangement can be omitted. The stator module therefore includes a short axial length.

In one embodiment, at least two stator segments of a stator segment chain are arranged immediately adjacent to each other in the circumferential direction with the coils of these stator segment including an opposite winding direction and the connection between the coils being described by a short connection path of the first or the second type. The differentiation between the connection paths of the first and the second type occurs depending on the length of the coil end of the upstream-arranged coil of a phase strand. When the coil ends at the upstream arranged stator segment in the common groove towards the coil arranged downstream in the phase strand a particularly short connection can be achieved. This connection path of the first type represents a so-called short connection between the adjacently arranged coils, which is realized by guiding the winding wire from the coil end in front of the common groove of the coil arranged upstream in the phase strand to the beginning of the coil arranged downstream in the phase strand, by the wire being arranged in the radially extending connection lines in the area of the recess between the coil heads of adjacent coils.

The connection to the coil arranged downstream in the phase strand as a connection path of the second type is longer and initially extends over the coil head of the coil arranged upstream because the last winding of the upstream arranged coil, after passing through the boundary groove, ends with a different adjacent stator segment. The wire progression of the connection path is then guided in the recess between the two coil heads into the yoke or head area and from here to the start of the coil arranged downstream in the phase strand.

The tangentially extending parts of the connection lines are located either axially in front of the yoke area or axially in front of the pole shoe area of the stator module.

Furthermore, optionally or additionally it is possible to arrange at least a portion of the stator segment chain at a distance from each other in the circumferential direction by more than one stator segment, with the off-set preferably amounting to 180°. When parts of the stator segments of the stator segment chain are arranged off-set in reference to each other in the circumferential direction the individual parts form stator segment groups. The individual stator segments group is each formed by at least one stator segment, preferably a plurality of stator segments. The connection between the stator segment groups is described by a long connection path of the first or second type, with this long connection path extending over at least one or a plurality of stator segments arranged therebetween. In one embodiment, the individual stator segment groups include pairs of stator segments with two stator segments arranged adjacent to each other in the circumferential direction, with the direction of winding between the stator segments of a pair of stator segments occurring opposite each other, as already described. Each of the individual stator segment groups can also include more than two stator segments, with also the statement regarding the direction of winding of stator segments adjacent to each other in the circumferential direction applying as well. Using the long connection paths, there is the option to couple the stator segments of a phase strand, which are arranged and fastened at different locations over the circumference of the stator module. By the option of creating stator segment chains, which includes the connection of the coils of stator segments adjacent to each other in the circumferential direction, the possibility develops to create stator segment chains, which can extend over a very large range of extension in the circumferential direction of a stator module, free from connection sites between the individual coils of the individual stator segments and only includes a respective connection at the beginning and the end section of the individual stator segment chain. This way, with the exclusive use of short connection paths of the first or the second type very compact stator segment chains can be pre-fabricated and warehoused and later assembled to a stator module in a simple fashion. This applies accordingly also for stator segment chains with long connections or a combination of short and long connections.

In one embodiment, a combination of stator segment chains can be used, which includes the arrangement or embodiment of stator segments with coils coupled to each other via short connections and via long connections.

In another embodiment, it is possible to embody the stator module only from stator segment chains with short connections.

In order to keep the required construction space in the axial direction as small as possible, preferably the connection paths between two subsequent individual coils at the facial area of the magnetically soft stator segments essentially include an axial distance exceeding the maximum distance of the exterior coil head surface by less than the thickness of a wire.

In yet another embodiment, the connection paths are arranged between two subsequent coils of a stator segment chain at a distance in the axial direction from the facial area of the individual stator segments, which is equivalent to maximally the distance from the surface of the coil head. This way, the connections are created in the axial area of the coil head and require no additional construction space in the axial direction. The latter option includes a short, for example, in a largely avoided extension of the connection paths in the axial direction outside the oil heads.

In order to directly lay the connections into the level of the stator module it is provided to arrange at least a partial section of the connection path forming the connection between two coils of a stator segment chain, at least partially, in the radial direction in a recess between two coil heads arranged subsequent to each other in the circumferential direction. This allows the possibility to shift the guidance of the short connection path of the first and the second type even within the distance between two parallel levels described by the exterior diameters of the coil heads or into the axial area of the extension of the coils. Such a guiding of the wire progression occurs primarily in the case that the last winding fails to radially exit the groove at the edge. If this is not the case and the coil end ends at the radial exterior or interior edge of the groove, the wire is guided in tangentially extending connection paths axially in front of the yoke or pole-shoe area of the stator module.

In general, during the progression of the connection paths in the tangential direction and in the axial direction inside the extension of the windings of the exterior layers of the wires forming the coils two options are distinguished, with the first one including the outlet of the coil end of the coil arranged upstream in the winding direction from the common groove with the stator segment arranged downstream in the circumferential direction and the coil surrounding it. The second embodiment includes the outlet of the coil end of the coil arranged upstream in the winding direction from the non-common groove and the extension of the wire over the coil head to the recess of the coil heads in front of the common groove. For example, for the arrangement of long connection paths the progression of the winding wire occurs along the individual stator segments arranged in the circumferential direction such that the space available at the individual coils themselves, caused by the type of winding and the space remaining clear from windings of the upper layer in reference to the lower layer, is used to guide the winding wire. For example, the area of the coil is used, which is free from windings of the upper layer. Here, too, the long connection can be moved into the arrangement level of the individual coils.

The ends of the stator segment chains forming a winding are preferably arranged evenly distributed in the circumferential direction over the perimeter and the number of pairs of ends is equivalent to the phase number or a multitude of the phase number. Preferably, it is attempted to arrange all wound stator segments of a phase in one stator segment chain, if possible.

The intersections between the long connection paths are located in the area of the recess between two coil heads of different stator segment groups. This way, at the intersections the option develops to press the winding wire extending closer to the magnetically soft stator segment, by the winding wire located over top of it, into the recess so that the lower wire progression is axially deformed and the upper wire progression can extend at a distance equivalent to the distance of the exterior layer in the coil head.

Preferably, a round wire is used as the winding wire. The winding of the individual coils themselves occurs beneficially ortho-cyclically in order to yield a high fill density.

The method according to the invention is essentially determined by the processing steps described in the following: Providing individual isolated stator segment cores and a housing accepting them, positioning the stator segments of a stator segment chain at a winding tool, creating coils of the stator segment chain from a winding wire, and positioning the stator segment chains of all phases to form a ring and alignment/fastening.

Different options are possible with regards to the winding method. Either the stator segments to be wound are arranged stationary and the winding wire is guided, for example via a winding needle, or the stator segment is moved in reference to the winding wire. Both options can also be implemented when winding the stator segment chains. Using the option mentioned first, however, generally, for example, compact pairs of stator segments can be created, i.e., stator segments, which are arranged directly following each other when installed in the circumferential direction. The winding tool used for the winding process includes a support device with at least two different accepting or support axes for the stator segments, with the support axes to wind the stator segment following in the stator segment chain being inclined in reference to each other in reference to the support axis of the upstream arranged stator segment of a phase at an angle and in this tilted state the winding occurs by creating the short connection path between the coils of the stator segments following each other in the circumferential direction. Here, depending on implementation, the short connection path may be created directly in the angled area of the stator segments positioned in this manner, with the connection then occurring between end sections of the stator segments identical in the installed position or by way of utilizing the angle of the tilting. In the latter case, the connection path describes the connection between the installed positions of end sections of stator segments different in the radial direction.

After the completion of the stator segment chain, the stator segments can once more be aligned in reference to each other and be brought into the end position in reference to each other, which occurs by way of tilt the support axis into a level including the support axis of the upstream arranged stator segment. This process may occur within the scope of the pre-fabrication or by way of tilting each stator segment about the central axis in reference to each other as late as during the assembly.

Preferably, when the individual stator segment chains are formed from multi-polar stator segment sectors with short connections of the first type and connections of the second type as well as long connections between the multi-polar stator segment sectors the assembly of the individual stator segment chains of the individual phases occurs successively.

Here, a simple axial motion is sufficient for the alignment of the stator segment chain of the first phase to be assembled. For the second phase several movements are required in the space, including radial and axial movements, while for additional phases the respective directions of motion may be further varied, with the long connection allowing different implementations.

The solution according to the invention can be used to create different stator modules with wound stator segments and at least two stator segments per phase. It is not restricted to a certain machine type with certain phase or pole numbers of a multi-phase electric machine. The electric machine may represent any internal rotor or an external rotor motor.

### BRIEF DESCRIPTION OF THE SEVERAL VIEWS OF THE DRAWING

The nature and mode of operation of the present invention will now be more fully described in the following detailed description of the invention taken with the accompanying drawing figures, in which:

FIG. 1 is a perspective view of one embodiment of a stator module;

FIG. 2 illustrates, based on a detail of FIG. 1, for a stator segment the realization of a short connection path of the first type between two coils subsequent in reference to the circumferential direction;

FIG. 3 illustrates, based on a detail of FIG. 1, the embodiment of the long connection path between the stator segments of two stator segment groups of a stator segment chain;

FIG. 4 illustrates as an example the arrangement of the individual stator segments for coiling;

FIG. 5 illustrates, as an example, the arrangement and switching developing for the coils of the stator segment chain B in its functional position;

FIG. 6 illustrates, based on a processing flow chart, the progression of a method for the production of a stator module.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and, as such, may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

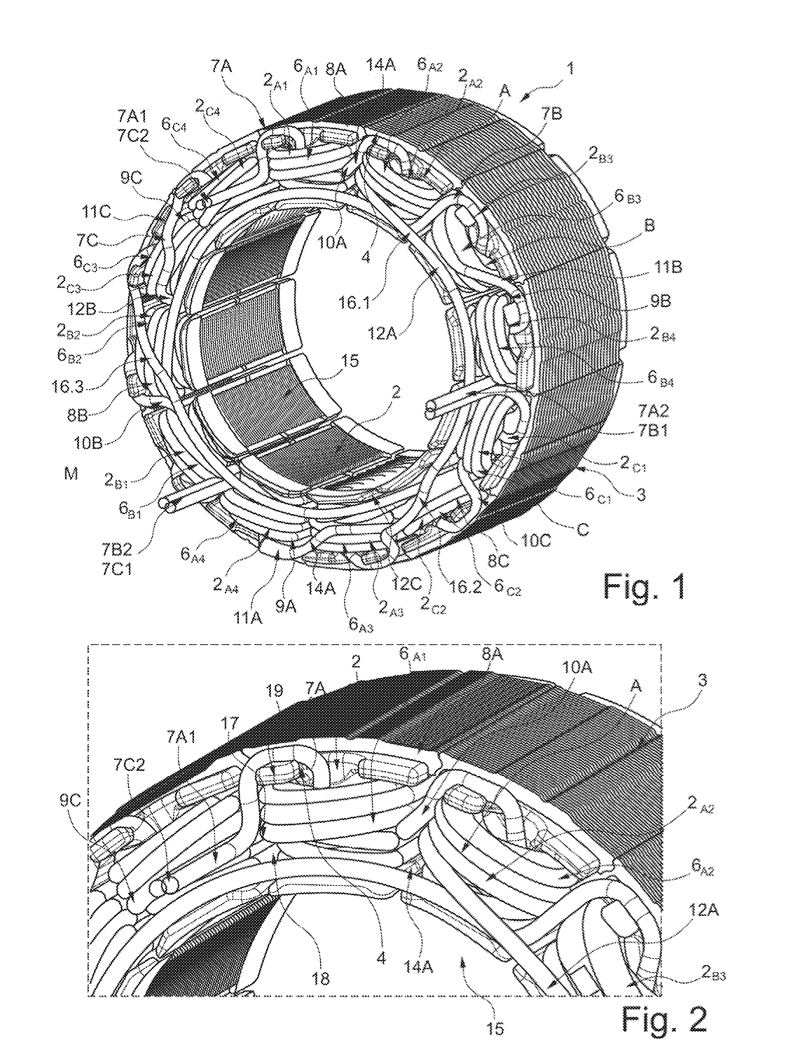

FIG. 1 illustrates in a schematically simplified view, based on a perspective illustration, the basic structure of stator module 1 embodied for use in electric inductive machines. Such machines are preferably used as actuator motors for automatic transmissions and therefore include a high power density due to the construction space available. The electric induction machine can be embodied with an external or internal rotor, with stator module 1 shown in FIG. 1 being used in an electric induction machine with an internal rotor.

Stator module 1 includes a plurality of stator segments 2, which are also called poles, and include toothed and yoke area 3. At the circumference individual stator segments 2 form angular sectors of the stator modules and abut in yoke area 3, with in the case shown the stator segments form contact site 4 approximately in the center of the groove. Individual stator segments 2 are arranged in the circumferential direction of stator module 1 adjacent to each other, forming grooves and including a magnetically soft material. The fastening of yoke 3 at a housing preferably occurs by impression of the pre-assembled stator module into a housing sheath, not shown, with a multitude of options being referred to, allowing a simple installation and exchange of individual stator segments 2. Depending on the multi-phase embodiment of the electric machine individual stator segments 2 are arranged in stator segment chains, here marked A through C, for an embodiment as stator module 1 for a three-phase induction machine. Here, one stator segment chain A through C each is allocated to a phase. Each of stator segment chains A through C includes at least two stator segments, which are wound with formation of coils 6, with the individual coils of stator segment chain A through C each being switched serially and formed by continuous winding wire 7A through 7C, i.e., free from joints. Instead of only one wire, two or more wires may also be wound parallel. In the case shown, stator module 1 may include, for example, stator segments 2, forming twelve poles, with stator segment chain A through C each being allocated to four such stator segments. The stator segments of stator segment chain A are here marked 2A1 to 2A4, the stator segments of stator segment chain B are marked 2B1 to 2B4, and the stator segments of stator segment chain C also marked 2C1 to 2C4. Each stator segment 2A1 to 2C4 is here wound with coil 6A1 to 6C4. Individual coils 6A1 to 6A4 of phase A are switched serially and formed by continuous winding wire 7A free from connections and interruptions or connectors required. In analogy, this also applies for coils 6B1 to 6B4, 6C1 to 6C4 allocated to stator segments 2B1 to 2B4 and 2C1 to 2C4. The coils are each formed by winding wires 7B and 7C. Each of stator segment chains A through C includes two stator segment groups, in the embodiment shown in FIG. 1 in the form of pairs of stator segments 8A, 9A or 8B, 9B, and 8C, 9C. The individual stator segments of a stator segment group, for example, a pair of the stator segment group of stator segment chain A through C, are arraigned in pairs immediately adjacent to each other in the circumferential direction. Within stator segment chain A stator segments 2A1, 2A2 form pair of stator segments 8A, while pair of stator segments 9A are formed by stator segments 2A3 and 2A4. In analogy thereto, this also applies to pair of stator segments 8B and 9B, each of which includes stator segments 2B1, 2B2, and 2B3, 2B4, as well as pairs of stator segments 8C and 9C, each of which formed by stator segments 2C1, 2C2, and 2C3, 2C4 and coils 6A1 to 6C4 allocated thereto.

The individual stator segments of pair of stator segments, here 2_{A1}, 2_{A2} of pair of stator segments 8A, 2_{B1}, 2_{B2} of pair of stator segments 8B, 2_{C1}, 2_{C2} of pair of stator segments 8C as well as 2_{A3}, 2_{A4} of pair of stator segments 9A, 2_{B3}, 2_{B4} of pair of stator segments 9B and 2_{C3}, 2_{C4} of pair of stator segments 9C, each with regards to their coils 6_{A1}, 6_{A2} for 8A, 6_{B1}, 6_{B2} for 8B, and 6_{C1}, 6_{C2} for 8C by a connection formed via winding wire 7A through 7C in a short connection path of first type 10A, 10B, 10C. For the connections of coils 6_{A3}, 6_{A4} for pair of stator segments 9A, 6_{B3}, 6_{B4} for 9B, and 6_{C3}, 6_{C4} for 9C the short connection paths of second type are marked 11A to 11C. The pairs of stator segments, for example, pair of stator segments 8A and pair of stator segments 9B of stator segment chain A, are further coupled to each other via connection path 12A, here of the second type, forming a long connection. The individual pairs of stator segments 8A and 9A of stator segment chain A are here arranged opposite each other in the circumferential direction, i.e., off-set by 180° in reference to each other. The coils of pair of stator segments, here 6_{A1} and 6_{A2} for pair of stator segments 8A and 6_{A3}, 6_{A4} for pair of stator segments 9A, include an opposite winding direction in order to ensure an appropriate alignment of the electric fields developing here. This applies in analogy also for coils 6_{B1}, 6_{B2} of pair of stator segments 8B, 6_{B3}, 6_{B4} of pair of stator segments 9B, 6_{C1}, 6_{C2} of pair of stator segments 8C, and 6_{C3}, 6_{C4} of pair of stator segments 9C.

Pairs of stator segments 8A, 9A or 8B, 9B, and 8C, 9C coupled to each other via long connection paths 12A through 12C are depicted in the concrete embodiment shown in FIG. 1, such that the coils provided at the beginning and end of long connection path 12A through 12C each show the same winding direction 6_{A2} and 6_{A3} or 6_{B2}, 6_{B3}, and 6_{C2}, 6_{C3}.

All coils 6_{A1} to 6_{A4}, 6_{B1} to 6_{B4}, and 6_{C1} to 6_{C4} are preferably wound ortho-cyclically with a round wire to achieve a high fill factor. The ortho-cyclical effect includes the available space being used optimally by the windings of the upper coil layer being placed in recesses in the coil layer arranged underneath it and the intersections of coil wires 7A through 7C, occurring exclusively in the coil heads, thus, outside the grooves.

The at least two coils of a stator segment group following each other in the circumferential direction, here pairs of stator groups 8A, 9A, 8B, 9B, or 8C, 9C are wound such that the connection path of first type 10A through 10C or second type 11A through 11C forming a short connection abstain from projecting axially beyond the coil head forming the winding head in assembled stator module 1. This is explained using pair of stator segments 8A as an example. Here, winding wire 7A in the area of the short connection path of first type 10A includes a radial extension in the recess between the coil heads of coils 6_{A1}, 6_{A2}. In one embodiment, the ends of the coils to be coupled to each other via short connections 10A or 11A, for example, coils 6_{A1}, 6_{A2} of stator segments 2_{A1}, 2_{A2} of pair of stator segments 8A, are embodied such that the windings of coil 6_{A1} of stator segment 2_{A1} end in the area of joint groove 14A forming between them, and thus, directly radially in the area of yoke 3 and are guided on this radius to the beginning of the coil following serially inside stator segment chain A, here 6_{A2}.

If the coil upstream in reference to the winding direction ends, for example 6_{A3}, not in common groove 14A, winding wire 7A is first guided once more over the winding head of coil 6_{A3}, as if another winding were to follow. At the end of crossing the coil head connection 11A is guided in the recess between two adjacent coil heads radially into the yoke area and extends in this radius to coil 6_{A4} following in the winding direction into the area of interior circumference 4 of yoke 3.

The connection paths of first type 10A, or second type 11A of the short connections, of two coils following each other serially, here coils 6_{A1}, 6_{A2}, and 6_{A3} and 6_{A4} therefore extend partially radially, with the progression occurring approximately at the symmetry line in the middle of groove 14A or 14A, using the recess between two adjacently arranged coil heads. The winding of following coil 6_{A2} or 6_{A4}, respectively, begins each at the exterior area of the individual stator segments, in radial direction, here 2_{A2}, 2_{A4}, i.e., in the area axially in front of yoke 3. Depending on the embodiment of grooves 14A and the shape of the coils, for example, a trapezoidal shape, the coil ends are usually located in the radially central groove area, i.e., the exterior layer of the coil is only partially filled. A long connection of second type 12A to coil 6_{A3} of pair of stator segments 9A occurs preferably in the radially inward end section of stator module 1 in the space not used by the exterior layers of the coils. For this purpose, winding wire 7A is tangentially guided along the coil heads passing the other phases from coil 6_{A2} in the direction towards coil 6_{A3}.

Such tangential connection sections in the progression of the connections between individual coils, particularly short connection paths of second type 11A and long connection paths of second type 12A, with stator segment chain A being an example, therefore show a distance from the facial area of the magnetically soft pole core in the form of respectively involved stator segments 2_{A1} to 2_{A4}, which is equivalent to the maximum distance of winding wire 7A in the exterior layer of coils 6_{A1} to 6_{A4}.

The connection paths of the second type, such as respectively long connections, here 12A for the connection of two pairs of stator segments 8A and 9A, are guided in stator module 1 shown in FIG. 1, passing in the radial direction in the area of internal circumference 15 of stator module 1 at the stator segments of stator segment chains B, C, of the other phases interposed in the circumferential direction. Here, for connection paths 12A to 12C the respective space available in the axial direction is used, which remains clear during the winding of individual coils 6_{A1} to 6_{C4} from the upper winding or the space remaining clear by the step provided in the individual winding in the coil heads. These steps in the coil or winding heads develop such that the exterior or the upper layer comprise less windings in reference to the exterior diameter of individual stator module 2_{A1} to 2_{C4} and they are located in the radial direction radially outside at stator module 1. The tangential width of the individual coil is larger, seen in the installation position in stator module 1 in the radial direction towards the exterior diameter, than in the area of interior circumference 15 of stator module 1.

The connection paths of second type 12A to 12C of individual stator segment chains A through C, such as the long connections, intersect each at one point. Here, the long connections of two stator segment chains each intersect, for example, A and B, A and C, or B and C. These intersections are marked 16.1 to 16.3 and are preferably also located in the area of a recess between adjacent coil heads, i.e., the intersection occurs such that the winding with exterior and intersecting in the axial direction exterior and intersecting winding wire, based on an uppermost layer of a previous coil is guided over another winding wire led along a lower layer of the same coil.

The respective ends of winding wire 7A to 7C of individual stator segment chains A through C, each of which respectively marked 7A1 and 7A2 or 7B1, 7B2, and 7C1, 7C2, are guided in the axial direction out of the arrangement level of stator segments 2_{A1} to 2_{C4} axial in the functional layer. The alignment occurs preferably in the area of an upper layer, with the fixation and guiding of the end sections occurring such that they are guided in a supported fashion in the radial direction in the area of yoke 3 and aligned in the radial direction to the center and in the area of the extension of stator segment 2_{A1} to 2_{C4} guided out of it, preferably in the central area in the axial direction.

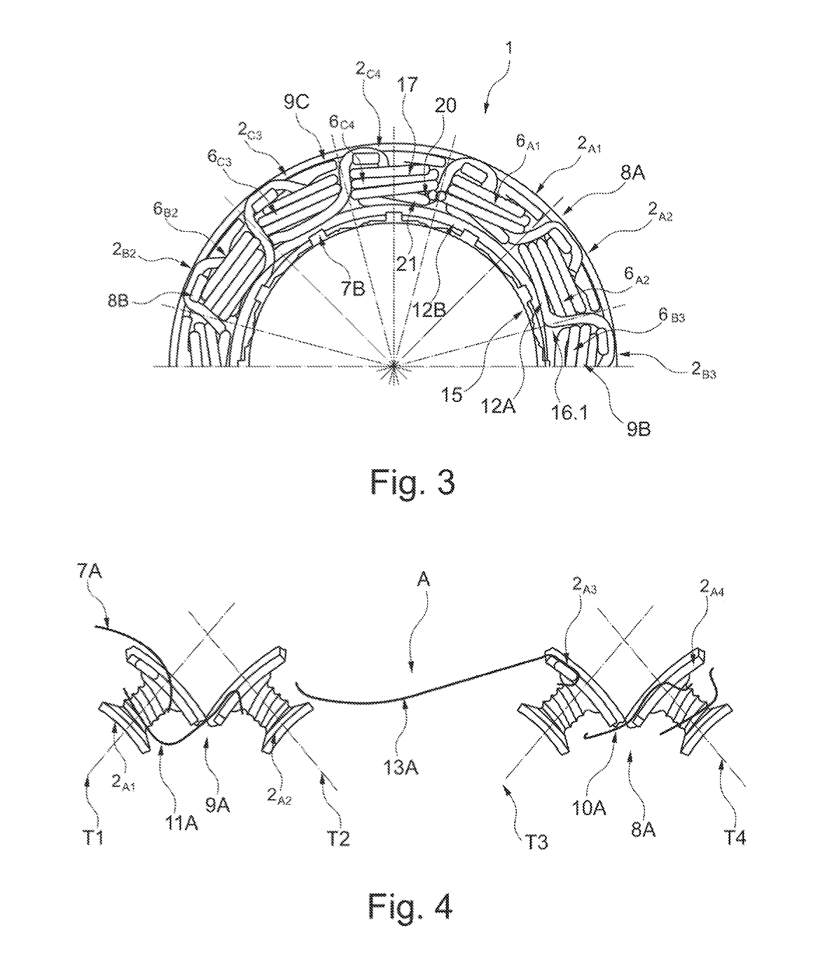

The individual particulars for the embodiment of the windings of a phase as one-part phase strands, i.e., free from interruptions, are disclosed in FIGS. 2 and 3 in a schematic, simplified illustration.

Here, FIG. 2 illustrates a detail of the radial progression of the connection path of first type 10A, such as the short connection, disclosed coils 6_{A1} and 6_{A2}. Here, for individual stator segment 2_{A1} and 2_{A2} are discernible the embodiments of coils 6_{A1} and 6_{A2}, end section 7A1 of winding wire 7A, which is guided (outing) in the axial direction the stator segment level together with end section 7C2 of winding wire 7C of stator segment chain C in pairs, with the guiding occurs in a 90 degree direction out of the level of stator module 1 and thus essentially parallel in reference to central axis M of stator module 1. Furthermore, the alignment of end section 7A1 is discernible, which forms the starting section of the serial switching realized via winding wire 7A of individual coils 6_{A1} to 6_{A4} of stator segment chain A, in reference to stator segment 2_{A1} at coil 6_{A1} formed here tangentially in reference to upper layer 17 of coil 6_{A1}, and out of the winding area into the interim space, here groove 18, to the stator segments of pair of stator segments 9C. End section 7A1 is fixed in the area of yoke 3 or fixed via respective area sections 19 of the coil body of stator segment 2_{A1}, which are here formed by projections.

Individual coils 6_{A1} and 6_{A2} are wound ortho-cyclically, with the upper layers each being placed in the interim spaces caused by the cross-section of the winding wire. The winding about the circumference of individual stator segment 2A₁ occurs at an angle in reference to the radial direction. The guiding of winding wire 7A occurs here in the installation position, seen from the radial exterior area in the direction towards radial interior circumference 15 of the stator module and back therefrom, with the transfer to coil 6A₂, switched serially in reference to coil 6A₁, occurring in the circumferential direction between interior circumference 4 of yoke 3 and interior circumference 15 of the stator module. Winding wire 7A is then guided via connection 10A from coil 6_{A1}, with its end section extending up to groove 14A, in the radial direction outwards in the area and/or parallel in reference to the central line of groove 14A into the radially outward yoke area of stator segments 2A₂. The guiding occurs here inside the recess created by the windings between the coil bodies of individual coils 6_{A1}, 6_{A2}.

With regards to the embodiment of the short connection of the second type, reference is made to the explanations regarding the connection between coils 6_{A3}, 6_{A4} in FIG. 1.

In a tangential guidance of winding wire 7A according to the second type is here illustrated for the coil end of coil 6_{A2}. It ends prior to the inlet into the next groove arranged in the circumferential direction, which is formed between stator segment 2_{A2} and stator segment 2_{B3} of stator segment chain B arranged adjacent to stator segment 2₂ in the circumferential direction. This guidance of winding wire 7A1 is included in the embodiment of the long connection path of second type 12A to couple pair of stator segments 9A, not shown here.

FIG. 3 illustrates, for example, based on a detail of FIG. 1, the tangential progression of longer connection 12B in front of gradually embodied coil heads. Here, for example, winding wire 7B is guided from stator segment 2_{B2} of stator segment group 8A to stator segment 2_{B3} of stator segment group 9B. Here, the guidance is discernible along the stator segments arranged in clear space 21 between them in the circumferential direction, in the detail of stator segments 2_{C3}, 2_{C4}, 2_{A1}, 2_{A2} of phases C and A shown through individual coils 6_{C3}, 6_{C4}, 6_{A1}, 6_{A2} based on the gradation between upper layer 17 and layer 20 located thereunder. It is provided, in reference to the location of the stator segments, in the functional location in the area of interior circumference 15 of stator module 1.

In intersection 16.1 of connection path 12B with connection path 12A, this intersects the winding of coil 6_{A2}, with the guidance occurring tangential in reference to the exterior, preferably upper layer 17 of coil 6_{A2}, at least partially in the radial direction. Only intersection 16.1 is preferably in the area of the gradation between the winding layers of coil, here 6_{A2}, and in the area of the recess between two coil heads of different pairs of coils (8A, 9B) or immediately adjacent thereof. This way, at intersection 16.1 the winding wire extending closer to the magnetically soft body, here winding wire 7B of winding wire 7A laying over top thereof, are pressed into the recess between the coil heads of coils 6_{A2} and 6_{B3}, so that winding wire 7B over long connection 12B is axially deformed and wire 7A of long connection 12A extends over it at a distance being equivalent to the distance of the exterior coil layer. Winding wire 7B crossing it here bends upwards from the tangential direction and is guided in the recess in the radial direction into the yoke area.

FIGS. 1 through 3 illustrate, for example, one embodiment of stator module 1 with three phases and 12 wound poles. However, it is also suitable for other pole numbers and arrangements of the wound stator segments. For example, all poles of a phase may be arranged in a circumferential sector, thus, the long connections are omitted. Due to the fact that the winding direction changes there are at best two different short connections of the first and second type, as already described, which can be inserted in the recesses between the individual coil heads. Furthermore, it is possible to vary the number of poles as well as the number of phases or to design a stator module with only long connections of the first or second type. Furthermore, it is possible in large strand cross-sections to use several parallel wound wires instead of a single one.

With regards to the production of such a stator module there are generally different options. However, all of them include the stator segments of stator segment chain A to C, which preferably describe a strand of a phase, each showing only one winding wire (or parallel wound wires) 7A, 7B, 7C free from interruptions, which form the serially switched coils 6_{A1} to 6_{C4} and which keep the connections between the individual, serially switched coils 6_{A1} to 6_{C4} as short as possible. FIG. 4 schematically illustrates in a simplified manner, based on a detail, the progression of the connection paths using as the example connection path 12A during the production and as pre-fabricated stator segment chain A. FIG. 6 illustrates, based on a signal flow chart, the progression of the method to produce stator module 1.

Here, in first processing step VA, in all embodiments the stator segments are provided in a stator segment chain and aligned in reference to each other by a winding tool. The arrangement at a winding tool is shown schematically in a very simplified fashion as an example in FIG. 4 for stator segment chain A. The alignment of individual stator segments 2_{A1} to 2_{A4} is essentially equivalent in reference to the circumferential direction of the position in which the stator segments are also aligned in reference to each other in finished stator module 1, with the individual pairs of stator segments 8A and 9A, which can be connected to each other via long connection path 12A, are arranged in a level or in the actual position at the support, not shown, of a winding tool. The alignment in the axial direction can be embodied differently, though. Here, embodiments of the winding of the stator segments of a stator segment chain with a fixed carrier and fixed stator segment and a winding needle which can be guided in the circumferential direction about the individual stator segments in order to guide the winding wire and embodiments with stator segments rotating in reference to the winding wire are distinguished from the stator segment. Preferably, the guiding of winding wire 7A occurs via a winding needle about stationary stator segments.

FIG. 4 illustrates the finished winding of stator segment chain A at a support device, not shown, of the winding tool, not shown. Only support axes T1 to T4 are shown for the individual stator segments. Support axes Tl, T2, and T3, T4 for stator segments 2_{A1}, 2_{A2} and 2_{A3}, _{2A4} directly adjacent in reference to the circumferential direction are arranged in reference to each other at an angle, with yoke area 3 of the stator elements each being folded out of the axial level in the circumferential direction of neighboring stator segments 2_{A2} and 2_{A4} in an angular range from preferably 20 degrees to 90 degrees in reference to previous stator segment 2_{A1} and 2_{A3}. For stator segment groups with a plurality of stator segments, which can be coupled via short connection paths of the first type, the arrangement and alignment at the tool can occur alternating tilted in reference to each other. At these support and fixation axes the stator segments are arranged and fixated and in subsequent processing step VB winding wire 7A is successively guided in the desired fashion about individual stator segments 2_{A1}, 2_{A2}, and 2_{A3}, 2_{A4} of stator segment chain A. Here, stator segments 2_{A1}, ²_{A2}, and 2_{A3}, _{2A4} arranged adjacent in the circumferential direction are each wound in different directions. Deviating from the stator segment chains in FIGS. 1 through 3, in FIG. 2 the production of a stator segment chain is shown, which after the first coil shows a short connection of second type 13A and subsequently after the second coil a long connection of the first type and after the third coil a short connection of the first type. The sequence of pairs of stator segment 8A and 9A is therefore inverted. Short connection 11A shown in FIG. 2 is here realized by the appropriate guidance of winding wire 7A out of the installation position radially inside stator segment 2_{A1} into the area exterior in the radial direction, which was folded out of the axial level, at stator segment 2_{A2}, and thus, subsequent coil 6_{A2}. Here, it is decisive that the direction of the winding is changed during the transfer. When according to FIG. 1, stator segment chain A includes pairs of stator segments preferably distanced from each other in the circumferential direction or preferably opposite each other in order to realize long connection path 13A the transfer between the stator segment groups 8A, 9A at the support device is also preferably guided at an annular segment or along a planar area. Other stator segment chains B, C can be produced similarly. The support axes can be tilted in an advantageous tool variant after the winding of the stator segments such that the opening angle between the polar heads of adjacent stator segments reduces to the final value and the intended narrow groove slit develops.

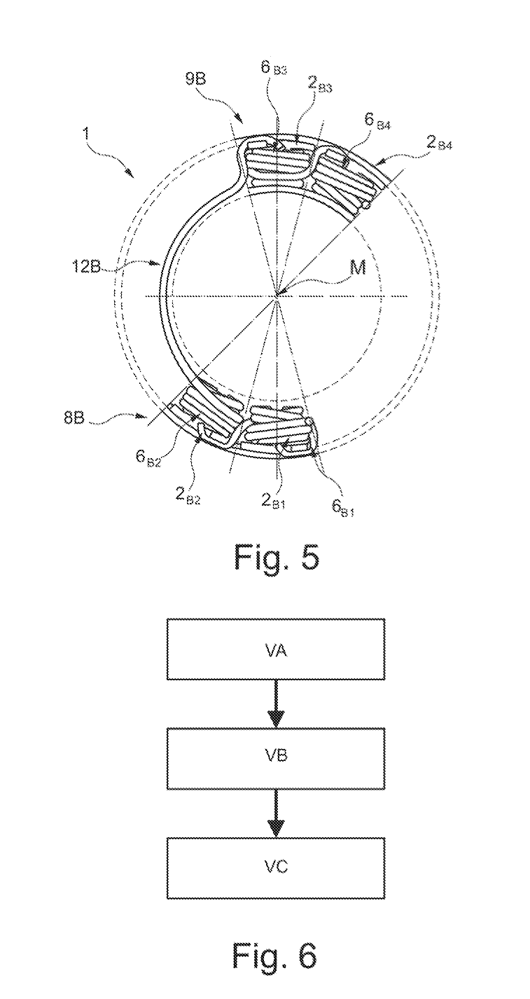

After the winding has occurred and the individual coils have been switched serially by single winding wire 7A to 7C for individual stator segment chains A to C they are provided in a pre-assembled form, which now can be aligned in processing step VC to annular yoke 3. Here, the assembly, alignment, and/or fastening of individual stator segment chain A through C, for example, for stator segment chain B, shown in FIG. 5, can occur by a simple insertion motion in the axial direction. Individual stator segments 2_{B1}, 2_{B2} and 2_{B3}, 2_{B4} were here folded in an axial level, in which they are aligned in the radial direction.

For next stator segment chain A or C to be assembled, then a plurality of overlapping motions is required in order to ensure an assembly, which here represents an axial and radial motion, while for last stator segment chain A or C then a respective additional alignment component is required for the assembly. For example, the last stator segment chain requires for the assembly a brief deflection of the pairs of stator segments in the radial direction.

Depending on the embodiment of the connection between the yoke areas of the stator segments it can occur in a force or form-fitting fashion and thus be embodied detachably or also permanently fixed.

The method for the production according to the invention is illustrated based on a signal flow chart shown in FIG. 6. Here in processing step VA, FIG. 6 illustrates the provision of a tool and the alignment of the individual stator segments at the tool and in processing step VB the winding process and in processing step VC the assembly to a ring, which can be inserted into a housing.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

### List of Reference Characters

1 stator module
2A₁-2A₄ stator segments
2B₁-2B₄ stator segments
2C₁-2C₄ stator segments
3 yoke
4 connection site
6A₁-6A₄ coil
6B₁-6B₄ coil
6C₁-6C₄ coil
7A, 7B, 7C winding wire
7A1 first end section
7A2 second end section
7B1 first end section
7B2 second end section
7C1 first end section
7C2 second end section
8A, 8B, 8C pair of stator segments
9A, 9B, 9C pair of stator segments
10A, 10B, 10C short connection of the first type within the pair of stator segments 8A, 8B, 8C
11A, 11B, 11C short connection of the second type within the pair of stator segments 9A, 9B, 9C
12A, 12B, 12C long connection of the second type between the pair of stator segments 8, 9
13A long connection of the first type
14A groove
15 interior circumference
16.1-16.3 intersection
17 upper layer, upper winding
18 groove
19 area section
20 bottom layer, bottom winding
21 clear space
A, B, C stator segment chains
M central axis
T1-4 support axes
VA, VB, VC processing steps

What is claimed is:

1. A stator module for multi-phase electric machines comprising:
a plurality of individual magnetically soft stator segments, arranged distanced in reference to each other in the circumferential direction and hereby forming grooves and wound with coils; and,
at least two coils being switched serially, wherein at least two stator segments of a phase form at least one stator segment chain, with their coils and the connection of the coils to each other being formed by a continuous winding wire or at least two parallel wound winding wires.

2. The stator module as recited in claim 1, wherein at least two connection paths between two subsequent coils of a stator segment chain show a distance in the axial direction towards the face of the stator segments, which exceeds the maximum distance of the exterior layer of the individual coils toward the face of the stator segments by less than one thickness of the winding wire.

3. The stator module as recited in claim 1, wherein at least two paths between two subsequent coils of a stator segment chain show a distance in the axial direction towards the face of the stator segments, which is maximally equivalent to the maximum distance of the exterior layer of the individual coil from the face of the stator segments.

4. The stator module as recited in claim 1, wherein at least two stator segments of a stator segment chain are arranged directly adjacent to each other in the circumferential direction, with the coils of these stator segments showing an opposite winding direction, where the connection between the coils can be described by a short connection path of the first type or the second type with the connection paths of the first type ending in the coil arranged upstream in the phase strand after passing through a common groove to the subsequent stator segment, while in the connection paths of the second type the coil arranged upstream in the phase strand ends prior to the inlet in the common groove to the subsequent stator segment and the winding wire must be guided over the upstream arranged coil.

5. The stator module ad recited in claim 1, wherein the stator segments of a stator segment chain form stator segment groups arranged in the circumferential direction offset in reference to each other by more than one stator segment, preferably by 180 degrees, each comprising at least one stator segment, where the connection between the stator segment group can be described by a long connection path of the first or second type, where in case of connection paths of the first type, the last coil of a stator segment group after passing a common groove, ends in the subsequent stator segment of another stator segment chain, while in connection paths of the second type, the last coil of a stator segment group ends prior to the inlet into the common groove to the subsequent stator segment of another stator segment chain and the winding wire must be guided over this coil.

6. The stator module as recited in claim 1, wherein at least one partial section of the connection paths describing the connection between two coils, of a stator segment chain extend at least partially in the radial direction in a recess between two coil heads of the coils of stator segments arranged adjacent in the circumferential direction.

7. The stator module as recited in claim 1, wherein at least a partial section of the connection paths describing the connection between two coils of a stator segment chain extends at least partially in a tangential direction in the radially interior area of the coils and are arranged in the axial direction inside the extension of the windings of the exterior layer of a coil.

8. The stator module as recited in claim 1, wherein the intersections of the long connection paths of two stator segment chains are arranged in the recesses between the coil heads of the coils of two adjacent stator segments.

9. The stator module as recited in claim 1, wherein the individual stator segments are wound ortho-cyclically.

10. A method for the production of stator modules comprising individually wound stator segments by aligning and fastening at a housing accepting them, wherein pre-fabricated stator segment chains are produced by the following processing steps:
providing and positioning stator segments to be wound at a winding tool under positioning of stator segments adjacent in the circumferential direction in the installed position at mutually tilted support axes;
creating the coils of the individual stator segments from a winding wire or parallel wound wires; and,
tilting the individually wound stator segments into an angular position in reference to each other, which assume them in the final stator module; and the individual stator segment chains created in this manner are aligned in an accepting tool or a common yoke and are fixated.
